(19) United States
(12) Patent Application Publication
(10) Pub. No.: US 2026/0178599 A1
(43) Pub. Date: Jun. 25, 2026

(54) MULTIMODAL INTERACTIVE VISUAL REPRESENTATION GENERATION

(71) Applicant: Adobe Inc., San Jose, CA (US)

(72) Inventors: Ajay Jain, San Jose, CA (US); Michele Saad, Austin, TX (US); Irgelkha Mejia, River Edge, NJ (US)

(73) Assignee: Adobe Inc., San Jose, CA (US)

(21) Appl. No.: 19/000,358

(22) Filed: Dec. 23, 2024

(51) Int. Cl. G06F 16/248; G06F 16/2457; G06N 20/00

(52) U.S. Cl. CPC G06F 16/248; G06F 16/24573; G06N 20/00

(57) ABSTRACT

Techniques for multimodal interactive visual representation generation are described. In an example, a processing device receives a user query that includes semantic parameters that define a context of a scene. The processing device generates a subset of digital assets by correlating one or more digital assets stored in a database to the semantic parameters. The processing device generates a prompt based on the semantic parameters that includes instructions for a machine learning model to generate a visual representation based on the query and the subset of digital assets. The machine learning model processes the prompt and the subset of digital assets to generate a visual representation that depicts the subset of digital assets integrated into the scene specified by the query. The processing device is further operable to receive an interaction to the visual representation and generate an updated visual representation based on the interaction.

### BACKGROUND

The proliferation of machine learning models and artificial intelligence has revolutionized image generation techniques. Accordingly, such techniques are widely implemented to synthesize diverse visual content using advanced machine learning techniques and/or algorithms. While conventional techniques are able to create high quality images, such techniques have a limited ability to incorporate specified details, context, and/or features. For instance, conventional approaches often lack flexibility and are unable to effectively incorporate particular objects, styles, or attributes into generated images. Additionally, systems that implement conventional techniques frequently require manual adjustment or restarting the process entirely when an initial output does not meet expectations, leading to limited creative control, inefficient use of computational resources, and increased power consumption.

### SUMMARY

Techniques for multimodal interactive visual representation generation are described that support personalized and controllable construction of visual representations. In an example, a processing device receives a user query that includes various semantic parameters that define a context of a scene. The processing device generates a subset of digital assets, such as by correlating one or more digital assets stored in a database to the semantic parameters. In some examples, the subset of digital assets is further based on profile data that includes information about a user associated with the query. The processing device generates a prompt based on the semantic parameters that includes instructions for a machine learning model to generate a visual representation based on the query and the subset of digital assets. The machine learning model processes the prompt and the subset of digital assets to generate a visual representation that depicts the subset of digital assets integrated into the scene specified by the query.

The visual representation is further interactive, such that the digital assets are selectable. For instance, the processing device receives an interaction to pin a particular digital asset. The processing device then generates an updated subset of digital assets that includes the pinned digital asset and at least one additional digital asset not included in the initial subset of digital assets. The processing device leverages the machine learning model to generate an updated visual representation that depicts the updated subset of digital assets within the scene. In this way the techniques described herein overcome the limitations of conventional techniques that experience a limited ability to selectively regenerate portions of a generated image while retaining a scene depicted by the generated image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the multimodal interactive visual representation generation techniques described herein.

FIGS. 2a, 2b, and 2c depict a system in an example implementation showing operation of a representation module of FIG. 1 in greater detail.

FIG. 3 depicts an example of multimodal interactive visual representation generation in which candidate representations are generated based on a user query.

FIG. 4 depicts an example of multimodal interactive visual representation generation in which a representation that includes various digital assets is displayed.

FIG. 5 depicts an example of multimodal interactive visual representation generation in which an interaction is provided to the visual representation.

FIG. 6 depicts an example of multimodal interactive visual representation generation in which an updated representation is generated and displayed.

FIG. 7 is a flow diagram depicting an algorithm as a step-by-step procedure 700 in an example implementation that is performable by a processing device to generate an interactive visual representation.

FIG. 8 is a flow diagram depicting an algorithm as a step-by-step procedure 800 in an example implementation that is performable by a processing device to generate an updated interactive visual representation based on an interaction.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Artificial intelligence (“AI”) based image generation techniques often leverage a variety of machine learning models that are trained on vast datasets of images to learn patterns, textures, and relationships within visual data. Accordingly, such models are implementable to produce high-quality and diverse images based on various inputs for a number of applications. However, while conventional techniques are able to rapidly create a variety of visually compelling content, such techniques often struggle to align outputs with specific user intents, such as to generate scenes that include particular objects or attributes.

For instance, conventional models that are trained on vast datasets often “overgeneralize” by learning to generate outputs that reflect common patterns, features, or relationships that are present in the training data. Accordingly, conventional techniques prioritize generalized representations, which limits an ability of these models to accurately generate images that include particular and/or requested objects. Further, conventional models often lack mechanisms to preserve specific regions and/or features of an image while modifying other regions and/or features, resulting in unintended changes to various portions of the image. Thus, conventional approaches often require manual adjustment or starting “from scratch” when an initial output does not meet expectations, leading to a variety of computational inefficiencies and limited creative control.

Accordingly, techniques for multimodal interactive visual representation generation are described that overcome conventional limitations. The techniques described herein, for instance, support generation of interactive visual representations that depict recommended digital assets, e.g., representations of particular goods and/or products, that are integrated into a scene that is generated based on various inputs such as a user query, user profile data, asset data, etc. The techniques described herein further support regeneration of an updated visual representation that retains specified aspects of the visual representation without causing off-target edits.

Consider an example in which a user of a processing device is planning a family hiking trip to the Swiss Alps and desires to purchase new clothing and equipment for the user and other members of the user's family. The user further wishes to visualize what the clothing and equipment will look like in a particular context, such as to ensure visual cohesion between the family members. In a conventional scenario, the user is forced to expend significant time and resources to browse for desirable products and manually compare the products to one another. Additionally or alternatively, conventional visualization tools lack an ability to view particular products within a desired scene and further lack an ability to retain scene elements during regeneration of images.

To overcome these limitations, a processing device receives a query, such as a text-based input from the user in a user interface. The query, for instance, is a natural language request for various task execution, such as to be performed by one or more machine learning models. The query further includes semantic parameters that that define an intent, purpose, and/or requirements of the query.

In at least one example, the semantic parameters define a context for a scene to be generated by a machine learning model as part of an interactive visual representation, such as an environmental setting, individuals to be included in the scene, actions and/or events to be depicted in the scene, spatial relationships, visual properties, and so forth. Continuing with the above example, the query includes a text string “A family of four hiking in the Swiss Alps in September.” In this example, the semantic parameters specify various features to be depicted by the scene, e.g., a number of individuals, an activity, a particular location, a time of year, etc.

Based on the query and the semantic parameters the processing device determines a query intent. In various examples, the query intent is further based on a variety of profile data associated with the user, such as user preferences, previous interactions, demographic data, etc. The query intent refers to an underlying purpose of the query as it relates to a particular task, e.g., a digital content generation task and/or an asset recommendation task, and includes information that is explicitly included in and/or is inferred from the query.

Based on the query intent, the processing device then generates a contextual embedding that includes information about a variety of digital assets, e.g., products, goods, services, etc., as well as one or more service provider systems associated with the digital assets. For instance, the processing device accesses an asset repository that includes a variety of asset data. In this example, the asset repository is associated with a particular online merchant and includes a “catalog” of products as well as information about the products. Accordingly, the contextual embedding captures information about the merchant (e.g., target market, brand, inventory, etc.) as well as information about particular products, e.g., which products “go well together,” which are likely of interest to the user, etc.

Based on the query intent and the contextual embedding, the processing device generates a prompt for processing by a machine learning model, e.g., a multimodal image generation model. The prompt represents a structured input for the machine learning model to guide the model to perform a specific task, e.g., to generate the visual representation. In this example, the prompt includes the query intent, the contextual embedding, and instructions to guide the machine learning model.

The processing device further generates a subset of digital assets based on the query intent. The subset of digital assets, for instance, includes visual representations of recommended goods or services from the asset repository that correspond to the semantic parameters of the query. In various examples, the subset of digital assets is further based on relationships of the digital assets to one another, such as products that “go well together,” e.g., are visually complementary.

Continuing with the example, the subset includes images of products from the catalog of products that are likely of interest to the user and go well together, and thus are to be included in the visual representation. For instance, the subset includes a pair of hiking boots, a warm hat, a rain jacket, and a backpack for various members of the family.

The processing device then implements the machine learning model to process the subset of digital images and the prompt to generate the visual representation. The visual representation, for instance, depicts the digital assets from the subset integrated into the scene specified by the query. In this example, the visual representation depicts a family of four at a particular spot in Swiss Alps, e.g., a well-known vista, with weather conditions consistent with September. Further, members of the family are depicted as wearing the hiking boots, warm hat, rain jacket, and backpack.

The processing device further generates the visual representation to be interactive, such that the digital assets are selectable. For instance, the user wishes to keep the hiking boots and warm hat, however, does not like the rain jacket and backpack. Accordingly, the user interacts with the visual representation to pin the hiking boots and warm hat.

The processing device is configured to generate an updated visual representation based on the interaction. For instance, the processing device generates an additional subset of digital assets that includes the hiking boots and warm hat, however, replaces the rain jacket and backpack with alternative products. The processing device leverages the machine learning model to generate the updated visual representation, such as based on the initial visual representation, an updated prompt that includes the interaction, and the additional subset of digital assets.

The updated visual representation depicts the updated subset of digital assets within the scene without causing unintended edits. For instance, the updated visual representation depicts the vista in the Swiss Alps with same visual properties as the scene depicted in the initial visual representation, however the rain jacket has been replaced with a poncho and the backpack has been replaced with a smaller sling pack. In this way, the techniques described herein overcome the limitations of conventional techniques that exhibit a limited ability to selectively regenerate portions of a generated image while retaining content of the generated image. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Term Examples

As used herein, the term “query” refers to an input to a machine learning model. The query, for instance, represents a natural language question and/or command provided in a user interface to a digital assistant that implements the machine learning model. In one or more examples, the query includes a natural language request for information, task execution, search functionality, personalization, etc. to be performed by the machine learning model. In various examples, the query includes one or more semantic parameters.

As used herein, the term “semantic parameters” are elements of a query that define an intent, purpose, and/or requirements included in the query. For instance, semantic parameters provide meaning to a query beyond literal terms included in the query. In at least one example, the semantic parameters define a context of a scene to be generated by a machine learning model, such as an environmental setting, individuals to be included in the scene, actions and/or events to be depicted in the scene, spatial relationships, visual properties, and so forth.

As used herein, the term “digital asset” refers to visual representations of one or more objects, such as digital representations of various products, goods, and/or services. In various examples, the digital assets include one or more digital images, videos, AR/VR content, three-dimensional renderings and/or models, etc. In some examples the digital assets are further associated with a variety of metadata, such as one or more tags, descriptions, specifications, etc.

As used herein, the term “query intent” refers to an underlying purpose of a query as it relates to a particular task. In various examples, the query intent is an embedding that includes one or more attributes, features, and/or a context explicitly included in and/or inferred from the query. For instance, the query intent represents one or more objects, features, contexts, styles, colors, purposes, perspectives, spatial and/or conceptual relationships, settings, etc. to be represented by the scene within the visual representation.

As used herein, the term “contextual embedding” refers to a string-based representation that captures various attributes of one or more digital assets and/or various attributes of a service provider system associated with the digital assets. For example, the contextual embedding includes an asset embedding, e.g., an embedding space that includes information particular to one or more digital assets. The contextual embedding also includes a provider embedding, e.g., an embedding space that includes information particular to a service provider system associated with the digital assets.

As used herein, the term “prompt” refers to a structured input to guide a machine learning model to perform one or more functionalities. A prompt, for instance, is configured based on a query to guide the machine learning model to perform various functionality such as to generate a visual representation. In one or more examples, the prompt includes one or more task instructions and/or a contextual embedding.

As used herein, the term “generation model” refers to a multimodal image generation machine learning model configurable to receive a variety of inputs (e.g., text-based, digital image-based, voice-based, etc.) to generate visual content. The generation model, for instance, is configurable to implement one or more artificial intelligence algorithms to synthesize digital content to align with a provided context and/or parameters. For example, the generation model generates a visual representation to depict one or more digital assets within a scene specified by a query.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

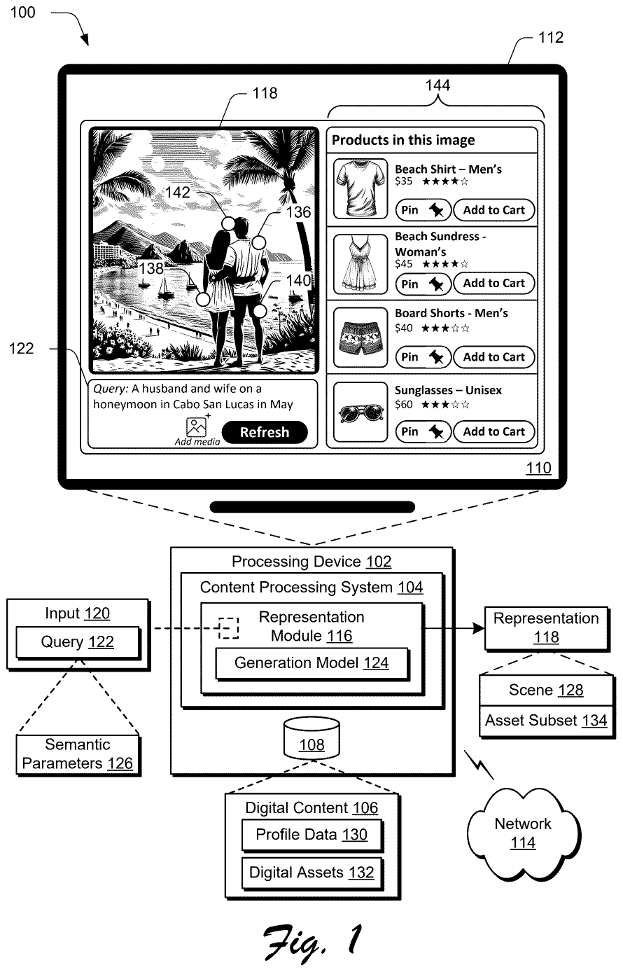

FIG. 1 is an illustration of a digital medium environment 100 in an example implementation that is operable to employ the multimodal interactive visual representation generation techniques described herein. The illustrated digital medium environment 100 includes a processing device 102, which is configurable in a variety of ways.

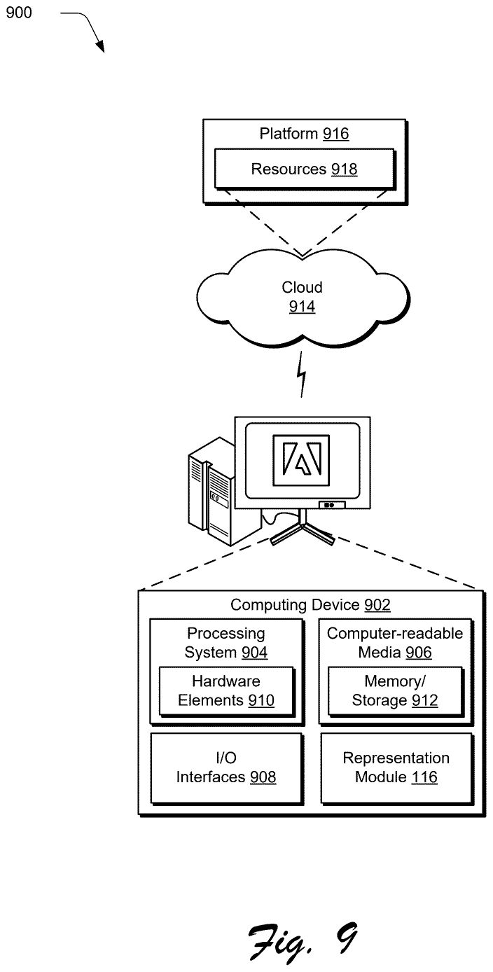

The processing device 102, for instance, is configurable as a computing device such as a desktop computer, a laptop computer, a mobile device (e.g., assuming a handheld configuration such as a tablet or mobile phone), and so forth. Thus, the processing device 102 ranges from full resource devices with substantial memory and processor resources (e.g., personal computers, game consoles) to a low-resource device with limited memory and/or processing resources (e.g., mobile devices). Additionally, although a single processing device 102 is shown, the processing device 102 is also representative of a plurality of different devices, such as multiple servers utilized by a business to perform operations “over the cloud” as described in FIG. 9.

The processing device 102 is illustrated as including a content processing system 104. The content processing system 104 is implemented at least partially in hardware of the processing device 102 to process and transform a variety of digital content 106, which is illustrated as maintained in storage 108 of the processing device 102. Such processing includes creation of the digital content 106, modification of the digital content 106, and rendering of the digital content 106 in a user interface 110 for output, e.g., by a display device 112. Although illustrated as implemented locally at the processing device 102, functionality of the content processing system 104 and/or the storage 108 is also configurable in whole or in part via functionality available via the network 114, such as part of a web service, by one or more service provider systems, and/or “in the cloud.”

An example of functionality incorporated by the content processing system 104 to process the digital content 106 is illustrated as a representation module 116. The representation module 116, for instance, is operable to generate a representation 118, e.g., an interactive visual representation, based on an input 120 that includes a query 122, such as a user query.

The query 122, for instance, refers to a natural language question and/or command, such as to form a basis for an input to one or more machine learning models, e.g., a generation model 124. In an example, the query 122 is provided in the user interface 110, such as to a digital assistant (e.g., an AI based digital assistant) that implements a machine learning model. In various examples, the query includes a natural language request for information, task execution, search functionality, personalization, etc. to be performed by the machine learning model. A variety of formats for the query 122 are considered, such as text-based queries, voice-based queries, visual queries, gestural queries, etc.

The query 122 further includes one or more semantic parameters 126. The semantic parameters 126, for instance, are elements of the query 122 that define an intent, purpose, and/or requirements included in the query 122. For instance, the one or more semantic parameters 126 provide meaning to a query 122 beyond literal terms included in the query 122.

Examples of semantic parameters 126 include but are not limited to an intent of the query 122, entities and/or keywords extracted from the query 122 (e.g., times, places, objects, locations, dates, etc.), actionable elements and/or terminology, relationships of tokens of the query 122 to one another, and/or contextual information. In some examples, the semantic parameters 126 further include properties of the query 122 such as a language style of the query, presence of keywords or text strings in the query, sentiment analysis information, task classification information, spelling and/or grammar, etc.

In at least one example, the semantic parameters 126 define a context of a scene 128 to be generated by the generation model 124, such as an environmental setting (e.g., a time and place for the scene 128, weather, etc.), individuals to be included in the scene 128 (e.g., a number of and/or demographic information about individuals to be represented in the scene 128), actions and/or events to be depicted in the scene 128 (e.g., dynamic elements and/or activities), spatial relationships (e.g., positional arrangements of objects in the scene 128), visual properties (e.g., style, perspective, tone, format, etc.) and so forth.

Accordingly, the representation module 116 is configured to determine an intent of the query 122 based on semantic parameters 126 using a variety of techniques as further described in more detail below. In at least one example, the representation module 116 leverages profile data 130, which is depicted in this example as maintained in storage 108, to inform a variety of functionality. For instance, the representation module 116 analyzes/identifies the semantic parameters 126 based in part on the profile data 130.

The profile data 130, for instance, includes a variety of information, collected and/or inferred, that describes properties of one or more individuals, such as a user associated with the query 122. In various examples, the profile data 130 includes one or more of a user ID (e.g., a name), demographic information, device usage properties, browsing history, purchase behavior, historical interaction data (e.g., previous queries and/or turns with a digital assistant), sentiment analysis information, etc. Thus, the representation module 116 is operable to use the profile data 130 to tailor an experience to a particular user.

The storage 108 is further illustrated to include digital assets 132. The digital assets 132, for instance, are visual representations of one or more objects, such as digital representations of various products, goods, and/or services. In various examples, the digital assets 132 include one or more digital images, videos, AR/VR content, three-dimensional renderings and/or models, etc. In some examples the digital assets 132 are further associated with a variety of metadata, such as one or more tags, descriptions, specifications, etc. Although depicted as stored locally, it should be understood that in various examples one or more of the digital assets 132 and/or various data associated with the digital assets 132 are stored remotely, such as by one or more service provider systems.

Based on one or more of the query 122, the semantic parameters 126, the profile data 130, and/or the digital assets 132, the representation module 116 leverages a generation model 124 to generate the representation 118. The generation model 124, for instance, is a multimodal image generation machine learning model configurable to receive a variety of inputs (e.g., text, digital image, voice, etc.) to generate visual content, e.g., the representation 118.

Accordingly, the generation model 124 is configurable to implement one or more artificial intelligence algorithms to synthesize digital content to align with a provided context and/or parameters. For instance, the generation model 124 generates the representation 118 to depict one or more of the digital assets 132, e.g., an asset subset 134, within a scene 128 specified by the query 122. The asset subset 134, for instance, includes digital assets 132 that are likely of interest to a user of associated with the query 122, such as based on a correspondence of the digital assets 132 to the semantic parameters 126. A variety of techniques to identify the digital assets 132 of the asset subset are further described below.

In the illustrated example, a user of the processing device 102 plans to take a vacation and is searching for wardrobe recommendations for the user and an additional individual. The user provides a query 122, e.g., via text input to a query input field of a web implemented AI-based digital assistant that includes a string “a husband and wife on a honeymoon in Cabo San Lucas in May.” The representation module 116 receives the query 122 and leverages the generation model 124 to generate the representation 118, such as based on one or more of the query 122, the semantic parameters 126, the profile data 130, and/or on various properties of the digital assets 132 as further described in more detail below.

As depicted, the representation 118 includes a visual representation of a scene 128 that includes a couple at the beach as specified by the query 122. The representation 118 further depicts a set of digital assets 132 within the scene 128, e.g., an asset subset 134, such as a shirt 136, a sundress 138, board shorts 140, and sunglasses 142. The asset subset 134 is integrated into an environment of the representation 118, with realistic lighting, shadows, perspective adjustments, etc. to ensure a natural and cohesive visual appearance. The representation 118 further includes a side panel 144 that depicts information about the asset subset 134 as well as selectable indicia to perform various functionality.

In various examples, the representation 118 is interactive, such that the digital assets 132 included in the representation 118 are selectable to perform a variety of functionality. In the context of the illustrated example, the shirt 136, the sundress 138, the board shorts 140, and the sunglasses 142 are selectable to be “pinned.” For instance, the user of the processing device 102 likes the shirt 136 and the sunglasses 142, however does not like the sundress 138 or the board shorts 140. Accordingly, the user interacts with the representation 118 to “pin” the sundress 138 and the sunglasses 142.

The representation module 116 is operable to receive the interaction to pin the digital assets 132. Based on the interaction, as well as on one or more of the query 122, the semantic parameters 126, the profile data 130, and/or the digital assets 132, the representation module 116 leverages the generation model 124 to update the representation 118. The updated version of the representation 118, for instance, depicts a substantially similar scene 128 as the representation 118, however includes at least one additional digital asset 132, such as a representation of a hat, that is likely of interest to the user. This is not possible using conventional techniques that are unable to effectively incorporate objects into generated images and further experience limited control over retaining features in subsequently generated images. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Multimodal Interactive Visual Representation Generation

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagrams. As a result, the instructions are storable on a computer-readable storage medium that causes the hardware to perform the algorithm. In portions of the following discussion, reference will be made to FIGS. 1-9.

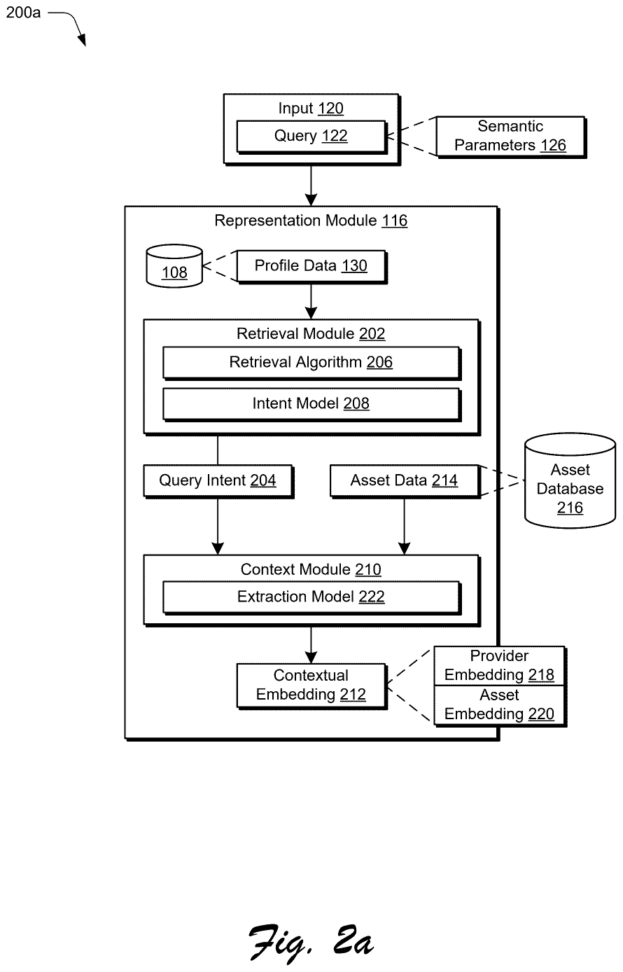

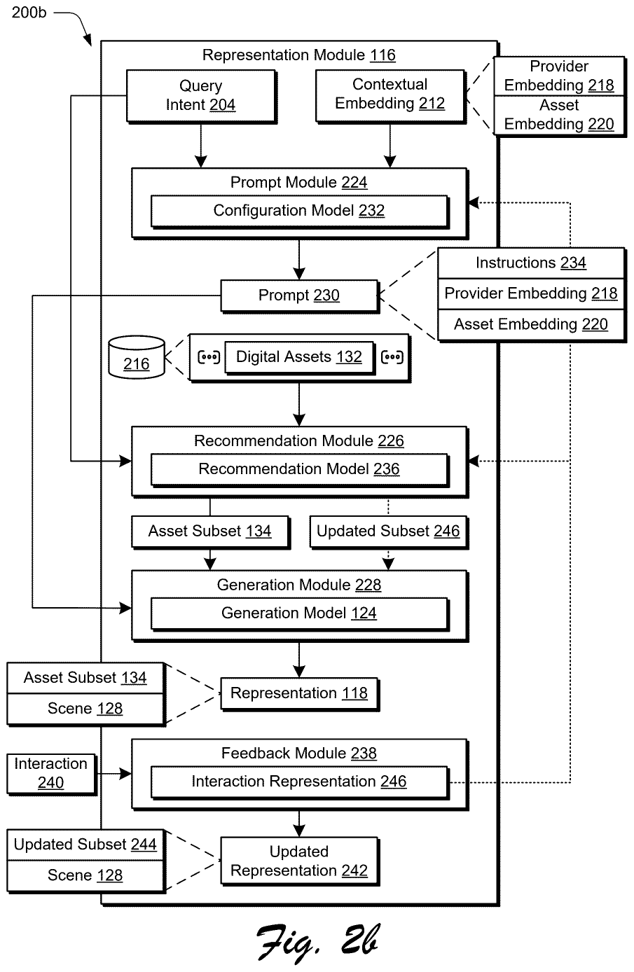

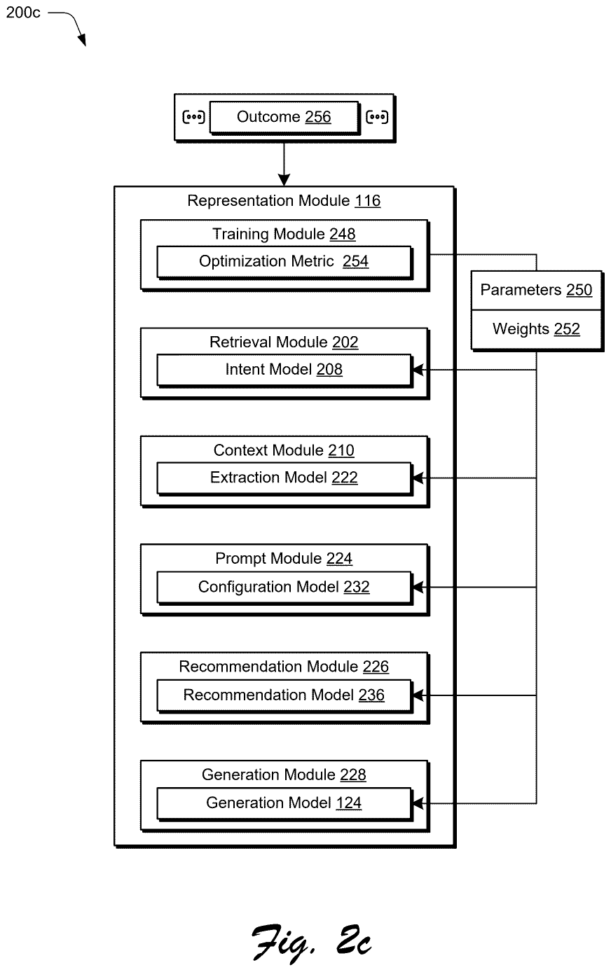

FIGS. 2a, 2b, and 2c depict a system 200a, 200b, and 200c in an example implementation showing operation of a representation module 116 of FIG. 1 in greater detail. Generally, the representation module 116 is operable to generate a representation 118 that depicts a scene 128 defined by a query 122 with one or more recommended digital assets 132 integrated into the scene 128. In various examples, the representation module 116 is further operable to receive one or more inputs to interact with the representation 118 and update the representation 118 accordingly, as described in more detail in the following examples.

In an example, the representation module 116 receives an input 120 that includes a query 122. As described above, the query 122 represents a natural language request for information, task execution, search functionality, personalization, etc. to be performed by one or more machine learning models of the representation module 116, such as the generation model 124. In various implementations, the query 122 defines a scenario for which to generate one or more recommendations, e.g., of products and/or services.

The query 122 includes one or more semantic parameters 126 that define an intent, purpose, and/or requirements included in the query 122, such as a meaning of the query 122 beyond its literal terms. As described above, the semantic parameters 126 define a context of a scene 128 to be generated by the generation model 124 for inclusion in the representation 118. For example, the semantic parameters 126 indicate a location, a time (e.g., time of day, season, etc.), individuals, and/or actions or events to be depicted in the scene 128.

The representation module 116 includes a retrieval module 202 that is configured to determine a query intent 204. The query intent 204 (e.g., a user intent) refers to an underlying purpose of the query as it relates to a particular task, e.g., a digital content generation task and/or an asset recommendation task. In various examples, the query intent 204 is an embedding that includes one or more attributes, features, and/or a context explicitly included in and/or inferred from the query 122. For instance, the query intent 204 represents one or more objects, features, contexts, styles, colors, purposes, perspectives, spatial and/or conceptual relationships, settings, etc. to be represented by the scene 128.

The retrieval module 202 is configured to generate the query intent 204 based on the query 122 and/or on a variety of additional data. In one or more examples, the retrieval module infers the query intent 204 based on profile data 130, e.g., information that describes properties of one or more individuals, such as a user associated with the query 122. Additionally or alternatively, the retrieval module 202 generates the query intent 204 based on location data, such as information associated with one or more locations included in the query 122. Location data, for instance, includes event-specific data (e.g., upcoming events), weather, local trends, cultural norms, holidays, etc.

The retrieval module 202 is operable to leverage a variety of techniques to generate the query intent 204. In various examples, the retrieval module 202 implements one or more of a retrieval algorithm 206 and/or an intent model 208 to infer the query intent 204. The retrieval algorithm 206, for instance, processes the query 122, such as using one or more natural language processing techniques, to identify the query intent 204. In one or more examples, the retrieval algorithm 206 further incorporates one or more contextual signals derived from the profile data 130 (e.g., user preferences and/or previous interactions) to refine the query intent 204.

Additionally or alternatively, the intent model 208 leverages the intent model 208 to infer the query intent 204. For instance, the intent model 208 implements one or more suitable machine learning models, techniques, and architectures, e.g., natural language processing, semantic embedding, classification models, transformer architectures (e.g., BERT, GPT, etc.), multimodal models, etc., to analyze the query 122. In one example, the intent model 208 infers the query intent 204 by analyzing a structure of the query 122, extracting key features of the query 122 such as keywords, entities, or relationships, and/or mapping the key features to predefined and/or dynamically learned intent categories. The intent model 208 is further operable to incorporate context from the profile data 130, such as prior interactions, user preferences, and/or domain-specific knowledge as part of generation of the query intent 204. This is by way of example and not limitation, and a variety of suitable modalities to infer the query intent 204 are considered.

The representation module 116 further includes a context module 210 that is operable to generate a contextual embedding 212 based on the query intent 204 as well as a variety of asset data 214. In this example, the asset data 214 is depicted as maintained in an asset database 216. The asset database 216, for instance, includes a plurality of digital assets 132, such as visual representations of one or more objects, goods, products, services, etc.

The asset database 216 further includes a variety of additional information associated with the digital assets 132, e.g., the asset data 214. The asset data 214, for instance, describes various properties and/or metrics associated with the digital assets 132. For example, the asset data 214 includes the digital assets 132 as well as various metadata that describe characteristics, usage, and/or context of the digital assets 132. In one or more implementations, the asset data 214 includes but is not limited to a name, description, price, dimensions, images, availability, and technical specifications, tags, categories, etc. of a particular digital asset 132. In various examples, the asset data 214 further includes usage statistics, such as customer reviews, ratings, social media statistics, and/or conversion metrics.

Additionally or alternatively, the asset data 214 includes temporal and/or geographical data associated with one or more digital assets 132. For instance, the asset data 214 indicates a geographical trend associated with one or more digital assets 132 at a particular time of day, year, season, etc. In this way, the context module 210 is configurable to filter the asset data 214, such as based on one or more of the semantic parameters 126 of the query 122.

While in this example the asset database 216 is depicted as external to the representation module 116, this is by way of example and not limitation. In one example, the asset database 216 is maintained by the processing device 102, such as included in storage 108. Additionally or alternatively, the asset database 216 is maintained via one or more service provider systems, and the representation module 116 is operable to obtain the asset data 214, such as via communication via the network 114.

In at least one example, the asset database 216 is specific to a particular service provider system. For instance, the particular service provider system is a merchant, and the asset database 216 includes representations of products that are associated with the merchant. In this example, the asset database 216 maintains asset data 214 that includes information about the products such as various metadata (product category, specifications, product name, price, ratings, usage information, etc.) as well as information about the particular service provider system, e.g., name, target markets, industry, inventory reports, performance metrics, historical insights, etc. Accordingly, the context module 210 is configured to generate the contextual embedding 212 based on a variety of information.

The contextual embedding 212, for instance, is a string-based (e.g., numerical-based) representation that captures various attributes of the asset data 214 as it relates to the query 122. In various implementations, the context module 210 configures the contextual embedding 212 in a compatible format with one or more machine learning models, such that the one or more machine learning models are able to comprehend and process the information included in the contextual embedding 212. Further, because the contextual embedding 212 is based in part on the query intent 204, which is in turn based on the semantic parameters 126 of the query 122, the contextual embedding 212 further includes information associated with one or more of the query intent 204, the query 122, and/or the semantic parameters 126.

In various examples, the contextual embedding 212 includes a provider embedding 218 as well as an asset embedding 220. The provider embedding 218, for instance, is an embedding space that includes information particular to a service provider system associated with the digital assets 132. For instance, the provider embedding 218 includes information about a particular merchant, such as name, target markets, industry, inventory reports, performance metrics, historical insights, etc.

The asset embedding 220, for instance, is an embedding space that includes information particular to one or more digital assets 132. For instance, the asset embedding 220 includes various metadata such as a product category, specifications, product name, price, ratings, usage information, etc. In various examples, the asset embedding 220 includes a refined set of recommended digital assets 132, e.g., digital assets 132 that are likely of interest to a user associated with the query 122.

For example, the context module 210 leverages an extraction model 222 to generate the contextual embedding 212. The extraction model 222, for instance, is a machine learning model configured to implement one or more suitable machine learning models, techniques, and architectures to receive as input the query intent 204 and a variety of asset data 214 and generate the contextual embedding 212. In at least one example, the extraction model 222 generates the asset embedding 220 to represent relevant digital assets 132 such as based on attributes of the query intent 204, the profile data 130, and/or various asset data 214.

Progressing to FIG. 2b, the representation module 116 is further depicted to include a prompt module 224, a recommendation module 226, and a generation module 228. Generally, the prompt module 224 is operable to generate a prompt 230 and the recommendation module 226 is operable to generate an asset subset 134 that form an input to the generation module 228. The generation module 228 is then configured to leverage the generation model 124 to generate the representation 118 based on the prompt 230 and the asset subset 134.

For example, the prompt module 224 receives the query intent 204 and the contextual embedding 212 as input. In various implementations, the prompt module 224 leverages a configuration model 232 to generate the prompt 230 based on the query intent 204 and the contextual embedding 212. The configuration model 232, for instance, is a machine learning model such as a large language model (“LLM”) that is trained to generate prompts to guide a machine learning model, e.g., the generation model 124, to perform various functionality based on various inputs.

For example, the configuration model 232 is configured to receive multimodal inputs, e.g., text, embeddings, images, etc. In various examples, the configuration model 232 includes one or more transformer layers that include attention mechanisms to prioritize particular input features, e.g., features of the query intent 204 and/or the contextual embedding 212. Thus, the configuration model 232 is able to analyze and integrate diverse input types, such as various queries, metadata, historical interactions, environmental context, etc.

During operation, the configuration model 232 is operable to encode input data into high-dimensional embeddings and process the embeddings through one or more of the transformer layers to capture various semantic and syntactic patterns. The configuration model 232 is further configured to generate the prompt 230 by decoding the embeddings. In this way, the configuration model 232 is able to incorporate aspects of the contextual embedding 212 and the query 122, e.g., the semantic parameters 126, into the prompt 230 in a form that aligns with the query intent 204.

Accordingly, the prompt 230 is a structured input that includes a variety of information that is configured to guide the generation model 124 during construction of the representation 118. For instance, the prompt 230 includes representations of one or more of the asset embedding 220 and/or the provider embedding 218. The prompt 230 further includes instructions 234 for the generation model 124 to generate the representation 118 based on the query 122. For instance, the instructions 234 describe desired attributes, content, and/or style of the representation 118.

In at least one example, the configuration model 232 includes a generative adversarial network, e.g., a “GAN”. For instance, the configuration model 232 includes a generator and a discriminator. The generator, for instance, is configured to produce sample prompts to be processed by the generation model 124. Accordingly, the generator is tasked with generation of sample prompts that produce relevant generated images, e.g., images that are suitable as representations 118, such that the generated images align with the query intent 204. In various examples, the generator is further tasked based on one or more optimization metrics, e.g., conversion. By way of example, a successful sample prompt is optimized to generate images that result in conversion.

The discriminator, for instance, evaluates the sample prompts generated by the generator. The discriminator is configured to assess a quality, relevance, and suitability of the sample prompts as inputs for an image generation model. The discriminator is further operable to evaluate the sample prompts based on the optimization metric. The discriminator, for instance, is configured to minimize a loss function and the generator is trained to augment an ability to generate sample prompts that result in high-quality images through iterative training. In this way, the generator is trained to generate realistic and high-quality representations 118 that highlight features of digital assets 132. This is by way of example and not limitation, and a variety of types, training modalities, and architectures of the configuration model 232 are considered.

The recommendation module 226 is operable to generate an asset subset 134 based on one or more of the query intent 204 and digital assets 132 stored in the asset database 216. The asset subset 134, for instance, includes digital assets 132 such as visual representations of one or more products, goods, services, etc. to be included in the representation 118. In various examples, the digital assets 132 of the asset subset 134 represent digital assets 132 that are recommended to a user associated with the query 122, such as based on a correspondence to the semantic parameters 126. For instance, the recommendation module 226 correlates one or more digital assets 132 to the semantic parameters 126 to generate the asset subset 134.

In an example, the recommendation module 226 includes a recommendation model 236, e.g., as part of a multi-item recommender system, that is trained to generate the asset subset 134. The recommendation model 236, for instance, is a machine learning model that is trained to identify a subset of digital assets 132 that aligns with the query intent 204. For instance, the recommendation model 236 is trained to understand and predict semantic relationships such as to correlate one or more semantic parameters 126 with one or more digital assets 132.

By way of example, the recommendation model 236 correlates a semantic parameter 126 that includes the text “hike” to digital assets 132 that represent outdoor apparel. In an additional example, the recommendation model 236 correlates a semantic parameter 126 that includes the text “December” to digital assets 132 that represent winter apparel. In at least one example, the recommendation model 236 generates a correlation score between each semantic parameter 126 in the query 122 and each digital assets 132 in the asset database 216. The recommendation model 236 then generates the asset subset 134 to optimize a net correlation score.

In various examples, the recommendation model 236 is further configured to optimize one or more objectives and/or metrics during generation of the asset subset 134. For instance, the recommendation model 236 receives the query intent 204 and various digital assets 132 as input and generates the asset subset 134 for inclusion in the representation 118 to maximize one or more objectives and/or metrics, such as conversion, user engagement, diversity, personalization, inventory optimization, user education, etc.

In various examples, the recommendation model 236 includes a collaborative filtering model that generates the asset subset 134 to include digital assets 132 based on preferences of similar individuals and/or relationships of different digital assets 132 to one another. For instance, the recommendation model 236 suggests digital assets 132, e.g., products, that are often purchased or interacted with together. Additionally or alternatively, the recommendation model 236 includes a content-based model that leverages attributes of the digital assets 132 (e.g., product features, descriptions, categories, relationships between the digital assets 132, etc.) and/or user history data to generate the asset subset 134. For example, the recommendation model 236 identifies digital assets 132, e.g., products, that are similar to products that a user associated with the query 122 has interacted with previously.

In various examples, the recommendation model 236 includes a hybrid model the combines collaborative filtering and content-based approaches, such as to derive a variety of insights during generation of the asset subset 134. This is by way of example and not limitations, and a variety of machine learning model architectures, types, and/or training modalities are considered, e.g., one or more natural language processing models, semantic embedding models, classification models, transformer architectures (e.g., BERT, GPT, etc.), multimodal models, etc.

In at least one example, the recommendation model 236 further receives additional data, e.g., environmental data and/or location data related to a detected destination included in the query 122 and generates the asset subset 134 based in part on the additional data. By way of example, the query 122 specifies a location and time of year, e.g., “London in the fall.” Accordingly, the recommendation model 236 generates the asset subset 134 based on this context, such as to recommend digital assets 132 that are in accordance with trends, weather conditions, events, etc. with the location and time of year.

The generation module 228 then receives the prompt 230 and the asset subset 134 to generate the representation 118. For instance, the generation module 228 implements a generation model 124 that processes the prompt 230 and the asset subset 134 to generate the representation 118. The representation 118, for instance, depicts one or more of the digital assets 132 included in the asset subset 134 incorporated into the scene 128.

In various implementations, the generation model 124 is a multimodal image generation machine learning model configurable to receive a variety of inputs (e.g., text, digital images, audio inputs, etc.) to generate visual content, e.g., the representation 118. In various examples, the generation model 124 includes one or more transformer-based model architectures (e.g., vision-language transformers), encoder-decoder frameworks, and/or hybrid neural networks that combine convolutional layers and/or attention mechanisms to process various input types. The generation model 124, for instance, is trained on one or more diverse datasets that include content from various modalities, such that the generation model 124 is able to learn cross-modal relationships to generate outputs. This is by way of example and not limitation, and a variety of machine learning model architectures, types, and/or training modalities are considered.

In one example to generate the representation 118, the generation model 124 generates a preliminary representation of the scene 128 based on the prompt 230. The preliminary representation, for instance, does not depict the asset subset 134. However, because the prompt 230 includes the asset embedding 220 (which in various examples includes a refined set of recommended digital assets 132 as described above) the generation model 124 is instructed to consider attributes (e.g., size, spatial relationships, positioning, integration behaviors) of the refined set of the recommended digital assets 132 during generation of the preliminary representation 118.

Accordingly, the generation model 124 generates the preliminary representation to include contextually adaptable “placeholders” within the scene 128. By way of example, the prompt 230 includes an asset embedding 220 that indicates that a long sleeve shirt, a backpack, and a baseball hat are recommended for a user associated with the query 122. Accordingly, the generation model 124 generates the preliminary representation to integrate representations, e.g., generalized representations, of a long sleeve shirt, a backpack, and a baseball hat. In at least one example, the generation model 124 generates the preliminary representation to include an empty region as a placeholder. In this way, the preliminary representation is configured to support seamless integration of particular digital assets 132, e.g., digital assets 132 included in the asset subset 134, into the preliminary representation.

The generation model 124 then generates the representation 118 via integration of one or more of the digital assets 132 into the preliminary representation. In an example, the generation model 124 decomposes the preliminary representation to identify a placeholder within the scene that aligns with a particular digital asset 132 of the asset subset 134. The generation model 124 then integrates the particular digital asset 132 into the preliminary representation such as by removing the placeholder and replacing it with the particular digital asset 132.

The generation model 124 is further configured to adjust visual properties of the digital assets 132, such as via a variety of post-processing operations. Continuing the above example, the generation model 124 is configured to align characteristics of the particular digital asset 132 (e.g., size, dimensions, orientation, lighting conditions, filters, visual styles, etc.) with contextual attributes of the placeholder and/or the preliminary representation. In this way, the generation model 124 incorporates various digital assets 132 from the asset subset 134 into the scene 128 to generate a visually coherent representation 118.

The generation module 228 further generates the representation 118 to be interactive, such that one or more of the digital assets 132 of the asset subset 134 are selectable. In one example, the generation module 228 associates selectable indicia, e.g., an icon, with each digital asset 132 included in the representation 118. The selectable indicia, for instance, are selectable to provide a variety of information about particular digital assets 132. In an example in which a digital asset 132 represents a product, actuation of the selectable indicia causes a of information to be displayed about the product, e.g., a price, similar products, sizes, etc. In an additional or alternative example, the digital assets 132 are selectable to be “pinned,” e.g., anchored as a preserved digital asset 132.

For instance, the representation module 116 includes a feedback module 238 that is operable to receive an interaction 240. The interaction 240, for instance, includes one or more user interactions with elements of the scene, receipt of an updated and/or refined query 122, modification of one or more filters, etc. Based on the interaction 240, the feedback module 238 causes one or more visual changes to the representation 118, such as to generate an updated representation 242. In at least one example, the updated representation 242 includes the scene 128, e.g., a substantially similar scene 128 as depicted by the representation 118, however includes an updated subset 244.

For example, the interaction 240 includes a user input to pin one or more of the digital assets 132 included in the asset subset 134 depicted by the representation 118. The user input indicates products that a user associated with the query 122 “likes” and desires to retain, such as digital assets 132 the user desires to be included in the updated representation 242. Accordingly, the non-pinned digital assets 132 are replaced with digital assets 132 of an updated subset 244.

To do so, the feedback module 238 generates an interaction representation 246 based on the interaction 240. The interaction representation 246, for instance, is configured as a structured representation that is compatible with one or more machine learning models, e.g., the configuration model 232 and/or the recommendation model 236. In various examples, the interaction representation 246 includes one or more of an action type of the interaction 240, a digital asset 132 associated with the interaction 240 (e.g., the one or more pinned digital assets 132), contextual information about the interaction 240, etc.

The feedback module 238 communicates the interaction representation 246 to one or more of the prompt module 224 or the generation module 228. For instance, the prompt module 224 generates an updated prompt based on the interaction representation 246. In an example, the updated prompt includes the interaction representation 246, the contextual embedding 212, the query intent 204, and/or various instructions 234.

Additionally or alternatively, the recommendation module 226 generates the updated subset 244 based on the interaction representation 246. For example, the recommendation model 236 further incorporates the interaction representation 246 as input. The recommendation model 236 generates the updated subset 244 to include the pinned digital assets 132 and replace unpinned assets with one or more additional assets from the asset database 216. The generation module 228 is then able to generate the updated representation 242 that depicts the updated subset 244 within the scene 128. This overcomes the limitations of conventional techniques that exhibit a limited ability to selectively regenerate portions of a generated image while retaining content of the generated image.

Progressing to FIG. 2c, in various examples the representation module 116 further includes a training module 248 that is operable to train and/or update one or more machine learning models of the representation module 116. For instance, the training module 248 is configured to iteratively learn one or more parameters 250 and/or adjust one or more weights of the intent model 208, the extraction model 222, the configuration model 232, the recommendation model 236, and/or the generation model 124.

In one or more examples, the various components, e.g., the different machine learning models, of the representation module 116 are configurable to be trained as a system during runtime (e.g., during implementation) using reinforcement learning. For instance, the training module 248 defines one or more optimization metrics 254 that define a desirable outcome for the system. In various implementations, the optimization metrics 254 include one or more metrics related to conversion, user engagement, diversity, personalization, inventory optimization, user education, etc.

The training module 248 is configured to monitor real-time data, feedback, and/or system performance, e.g., toward achievement of the one or more optimization metrics 254. For instance, the training module 248 receives one or more outcomes 256 as a result of generation of the representation 118 and/or the updated representation 242. The training module 248 then updates one or more parameters 250 and/or weights 252 of the various models of the representation module 116 based on the one or more optimization metrics 254. In various examples, the training module 248 employs one or more techniques such as online learning, reinforcement learning, and/or federated learning to generate the one or more parameters 250 and/or weights 252. In this way, the techniques described herein are constantly improved to achieve one or more optimization metrics 254.

This is by way of example and not limitation, and a variety of training schema and/or modalities are considered. For instance, the previous examples describe multiple instances of machine-learning models, e.g., the intent model 208, the extraction model 222, the configuration model 232, the recommendation model 236, and/or the generation model 124. In various examples, machine-learning models refer to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data.

Examples of machine-learning models include but are not limited to neural networks, convolutional neural networks (CNNs), long short-term memory (LSTM) neural networks, generative adversarial networks (GANs), large language models (LLMs), decision trees, support vector machines, linear regression, logistic regression, Bayesian networks, random forest learning, dimensionality reduction algorithms, boosting algorithms, deep learning neural networks, etc.

A machine-learning model, for instance, is configurable using a plurality of layers having, respectively, a plurality of nodes. The plurality of layers are configurable to include an input layer, an output layer, and one or more hidden layers. Calculations are performed by the nodes within the layers via hidden states through a system of weighted connections that are “learned” during training of the machine-learning model to implement a variety of tasks.

In various examples to train the machine-learning model, training data is received that provides examples of “what is to be learned” by the machine-learning model, i.e., as a basis to learn patterns from the data. The machine-learning system, for instance, collects and preprocesses the training data that includes input features and corresponding target labels, i.e., of what is exhibited by the input features. The machine-learning system then initializes parameters of the machine-learning model, which are used by the machine-learning model as internal variables to represent and process information during training and represent interferences gained through training. In an implementation, the training data is separated into batches to improve processing and optimization efficiency of the parameters of the machine-learning model during training.

The training data is then received as an input by the machine-learning model and used as a basis for generating predictions based on a current state of parameters of layers and corresponding nodes of the model, a result of which is output as output data, e.g., a search result, prompt, and so forth.

In various examples, training of the machine-learning model includes calculating a loss function to quantify a loss associated with operations performed by nodes of the machine learning model. The calculating of the loss function, for instance, includes comparing a difference between predictions specified in the output data with target labels specified by the training data. The loss function is configurable in a variety of ways, examples of which include regret, Quadratic loss function as part of a least squares technique, and so forth. Configuration of the training data is usable to support a variety of usage scenarios. In one example, the training data is configured for natural language processing, e.g., to infer intent, locate items, generate prompts, and so forth. A variety of other examples are also contemplated.

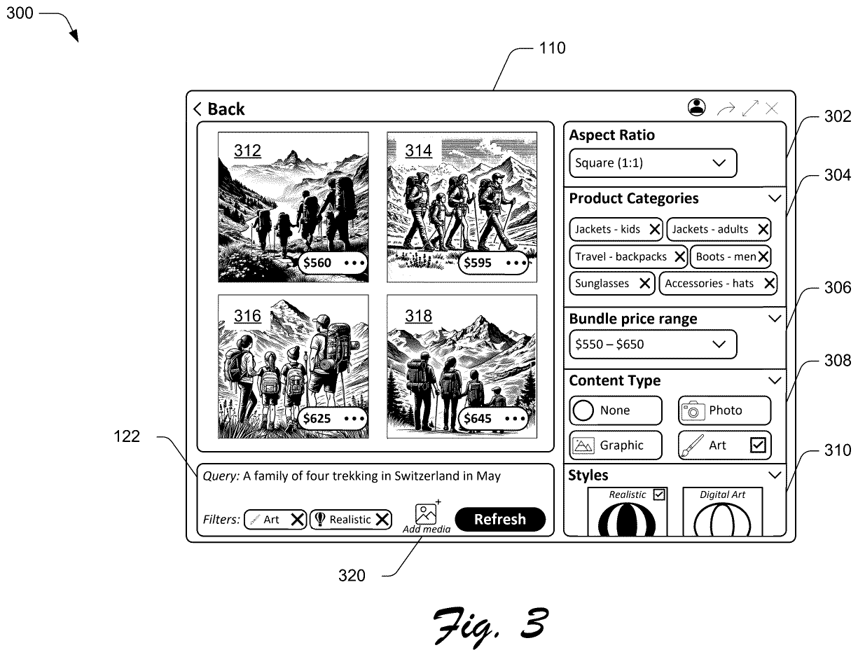

FIG. 3 depicts an example 300 of multimodal interactive visual representation generation in which candidate representations are generated based on a user query. In this example, a user is planning a vacation to Switzerland and is searching for appropriate and cohesive apparel for the user and the user's family members. The representation module 116 receives a query 122, such as user input provided in a user interface 110. As depicted in the illustrated example, the query 122 includes a text string “A family of four trekking in Switzerland in May.”

The user interface 110 further includes various filters and selectable indicia, such as an aspect ratio selector 302, a product categories selector 304, a price range selector 306, a content type selector 308, and a style selector 310. Each of the selectable indicia, for instance, influence generation of the prompt 230 and/or the asset subset 134. For example, the representation module 116 generates the prompt 230 to include representations of one or more of the selections and/or filters digital assets 132 based on the selections.

In accordance with the techniques described above, the representation module 116 generates several candidate representations based on the query 122 and the selectable indicia, such as a first candidate representation 312, a second candidate representation 314, a third candidate representation 316, and a fourth candidate representation 318. As illustrated, each candidate representation includes a price indicator that indicates a price associated with various digital assets 132, e.g., the asset subset 134 associated with each respective candidate representation.

The user interface 110 is further illustrated as including a media icon 320. Selection of the media icon 320, for instance, enables upload of one or more reference images. The representation module 116 is operable to generate the representation 118 based on the one or more reference images. For example, the generation model 124 receives a reference image as input and generates the scene 128 to include various properties of the reference image. In the context of the illustrated example, the user uploads a picture of the user's family, and the generation model 124 generates the representation 118 to depict the user's family in the scene 128 engaged with the asset subset 134, e.g., interacting with and/or wearing one or more recommended items.

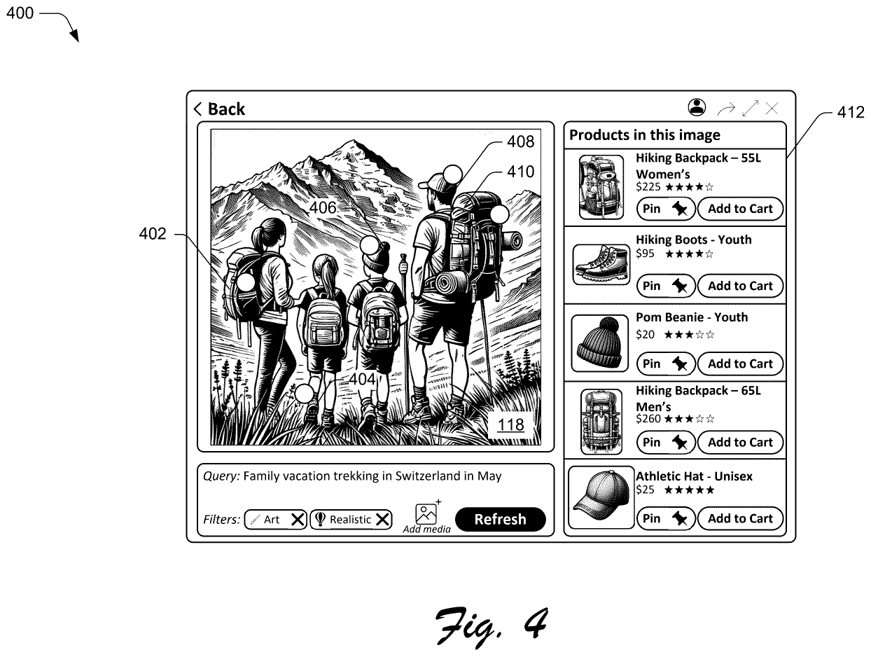

FIG. 4 depicts an example 400 of multimodal interactive visual representation generation in which a representation that includes various digital assets is displayed. The example 400, for instance, is a continuation of the example 300 discussed above with respect to FIG. 3.

In this example, the representation module 116 receives a user input, such as to select the third candidate representation 316. The representation module 116 generates the representation 118 based on the third candidate representation 316 and outputs the representation 118 for display in the user interface 110, such as in accordance with the techniques described herein. In the illustrated example, the digital assets 132 of the asset subset 134 include a first backpack 402, boots 404, a beanie 406, a second backpack 408, and a second backpack 410.

Each of the digital assets 132 are associated with a selectable icon, depicted as a white circle. The scene 128 depicts an environment based on the query 122, e.g., a mountainous scene in Switzerland with weather conditions in accordance with May. The user interface 110 further includes a side panel 412 that includes various properties of the digital assets 132 included in the asset subset 134, e.g., name, price, ratings, etc.

As described above, the asset subset 134 includes digital assets 132 that are likely of interest to a user associated with the query 122. For instance, the asset subset 134 is generated based on a correlation to semantic parameters 126, profile data 130 associated with the user, inferred information included in the query intent 204, environmental and/or collected data associated with the location and time, and/or properties of the various digital assets 132. In this way, the techniques described herein provide a consolidated representation of recommended digital assets 132, e.g., products for multiple individuals, in a visual context that the digital assets 132 will be used.

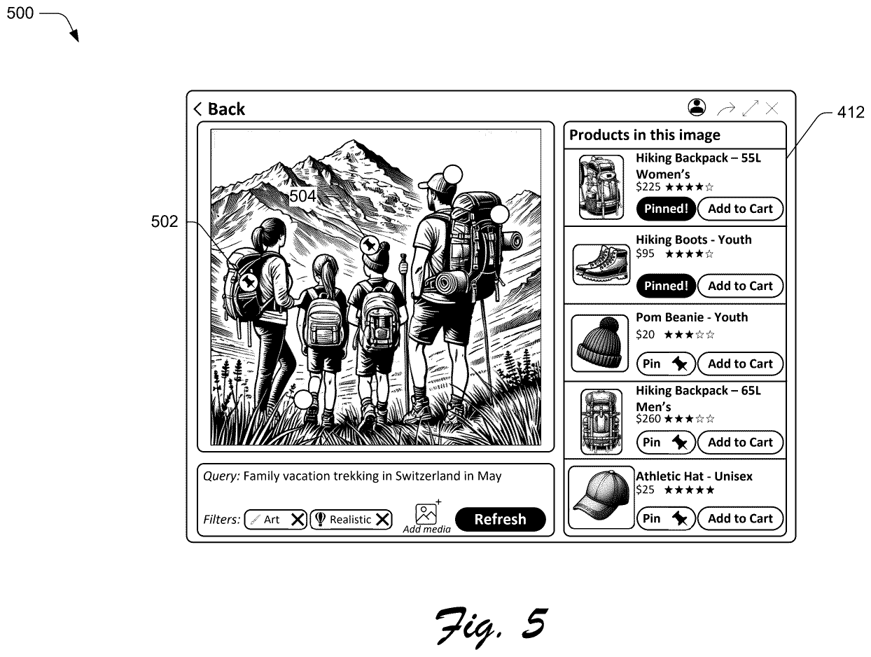

FIG. 5 depicts an example 500 of multimodal interactive visual representation generation in which an interaction is provided to the visual representation. The example 500, for instance, is a continuation of the example described above with respect to FIGS. 3 and 4.

In the example 500, the representation module 116 receives input to pin the first backpack 402 and the beanie 406. For instance, the user likes the first backpack 402 and the beanie 406, however wishes to replace the boots 404, the second backpack 408, and the second backpack 410 with alternative options. Accordingly, the user selects a pin icon 502 associated with the first backpack 402 and a pin icon 504 associated with the beanie 406 within the user interface 110. Additionally or alternatively, the user selects the icon to “pin” the first backpack 402 and the beanie 406 in the side panel 412.

Responsive to the action to pin the first backpack 402 and the beanie 406, the representation module 116 designates the respective digital assets 132 to be preserved during scene modification and/or generation of the interaction representation 246. For instance, the representation module 116 ensures that the one or more properties of the pinned assets (e.g., the first backpack 402 and the beanie 406) remain fixed and unaffected when other elements in the scene are adjusted, replaced, and/or regenerated. In various examples, the representation module 116 encodes one or more properties of pinned assets, e.g., a position, size, lighting conditions, etc. such as to maintain consistency during scene updates, post-processing operations, and/or subsequent image generation.

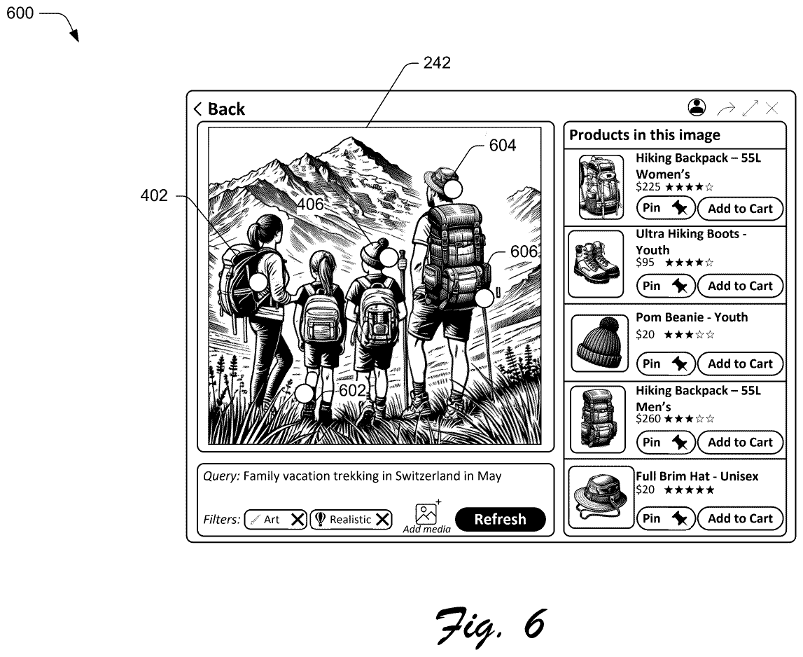

FIG. 6 depicts an example 600 of multimodal interactive visual representation generation in which an updated representation is generated and displayed. The example 600, for instance, is a continuation of the example described above with respect to FIGS. 3-5.

In this example, the representation module 116 generates an updated representation 242 in accordance with the techniques described herein, such as based on the interaction 240 and the pinned assets. The updated representation 242 includes a substantially similar scene 128 as the representation 118, e.g., the mountainous scene in Switzerland with weather conditions in accordance with May and a family of four in a foreground. The updated representation 242 further depicts an updated subset 244 that includes the pinned assets, e.g., the first backpack 402 and the beanie 406, however replaces the boots 404, the second backpack 408, and the second backpack 410.

For example, the updated representation 242 depicts the updated subset 244 which includes the first backpack 402, the beanie 406, ultra hiking boots 602, a full brim hat 604, and a smaller size backpack 606. Accordingly, the updated representation 242 includes representations of digital assets 132 that are likely of interest to the user, while preserving details of the scene 128. This overcomes the limitations of conventional approaches that lack mechanisms to preserve specific regions and/or features of an image while modifying other regions and/or features, which results in unintended changes to various portions of the image.

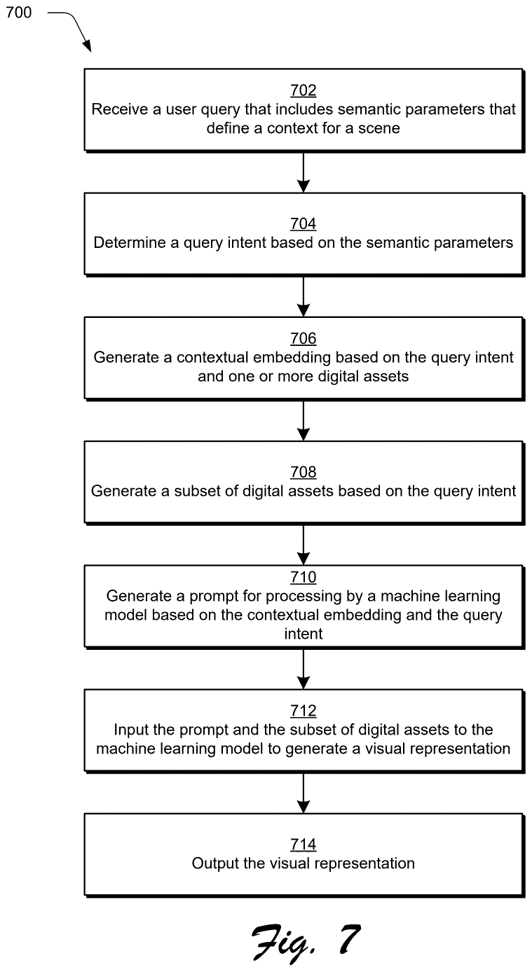

FIG. 7 is a flow diagram depicting an algorithm as a step-by-step procedure 700 in an example implementation that is performable by a processing device to generate an interactive visual representation.

To begin in this example, a user query in received (block 702). The user query, for instance, includes one or more semantic parameters 126 that define a context for a scene 128. In various examples, the semantic parameters 126 include an intent of the query 122, entities and/or keywords extracted from the query 122 (e.g., times, places, objects, locations, dates, etc.), actionable elements and/or terminology, relationships of tokens of the query 122 to one another, a language style of the query, presence of keywords or text strings in the query, sentiment analysis information, task classification information, spelling and/or grammar, various contextual information, etc.

A query intent is then determined based on the semantic parameters (block 704). The query intent 204, for instance, refers to an underlying purpose of the query as it relates to a particular task, e.g., a digital content generation task and/or an asset recommendation task. In various examples, the query intent 204 is an embedding that includes one or more attributes, features, and/or a context explicitly included in and/or inferred from the query 122. For instance, the query intent 204 represents one or more objects, features, contexts, styles, colors, purposes, perspectives, spatial and/or conceptual relationships, settings, etc. to be represented by the scene 128.

A contextual embedding is generated based on the query intent and one or more digital assets (block 706). The contextual embedding 212, for instance, is a string-based representation that captures various attributes of one or more digital assets 132 and/or various attributes of a service provider system associated with the digital assets 132. For example, the contextual embedding 212 includes a provider embedding 218 and an asset embedding 220.

The provider embedding 218, for instance, is an embedding space that includes information particular to a service provider system associated with the digital assets 132. For instance, the provider embedding 218 includes information about a particular merchant, such as name, target markets, industry, inventory reports, performance metrics, historical insights, etc. The asset embedding 220, for instance, is an embedding space that includes information particular to one or more digital assets 132. For instance, the asset embedding 220 includes various metadata such as a product category, specifications, product name, price, ratings, usage information, etc.

A subset of digital assets is generated based on the query intent (block 708). The asset subset 134, for instance, includes digital assets 132 such as visual representations of one or more products, goods, services, etc. to be included in the representation 118. In various examples, the digital assets 132 of the asset subset 134 represent digital assets 132 that are recommended to a user associated with the query 122. For instance, the asset subset 134 is generated by correlating the semantic parameters 126 of the query 122 to digital assets 132 stored in an asset database 216.

In an additional or alternative example, the representation module 116 leverages a recommendation model 236 that is trained to generate the asset subset 134. The recommendation model 236, for instance, is a machine learning model that is trained to suggest a subset of digital assets 132 that aligns the query intent 204 with properties of the digital assets 132. In at least one example, the asset subset 134 is generated based in part on a relationship of digital assets 132 from the asset database 216 to one another, e.g., digital assets 132 that have complementary properties and/or attributes.

A prompt is generated for processing by a machine learning model based on the contextual embedding and the query intent (block 710). The prompt 230, for instance, is a structured input that includes a variety of information to guide a machine learning model, e.g., the generation model 124, during construction of the representation 118. For example, the prompt 230 includes representations of one or more of the asset embedding 220 and/or the provider embedding 218. The prompt 230 further includes instructions 234 for the generation model 124 to generate the representation 118 based on the query 122. For instance, the instructions 234 describe desired attributes, content, and/or style of the representation 118.

The prompt and the subset of digital assets are input to the machine learning model to generate a visual representation (block 712). The machine learning model, for instance, is a multimodal image generation machine learning model such as the generation model 124 that is configured to receive a variety of inputs (e.g., text, digital images, audio inputs, etc.) to generate visual content, e.g., the representation 118.

In an example to generate the representation 118, the generation model 124 generates a preliminary representation of the scene 128 based on the prompt 230 that does not depict the asset subset 134. The preliminary representation includes one or more contextually adaptable placeholders. The generation model 124 then generates the visual representation by incorporating the asset subset 134 into the preliminary representation. For instance, the generation model 124 replaces the contextually adaptable placeholders with digital assets 132 from the asset subset 134.

The visual representation is then output (block 714). For instance, the representation module 116 causes the representation 118 to be presented, e.g., displayed in a user interface 110 of a display device 112. The representation 118 depicts the generated asset subset 134 within the scene 128 specified by the query 122.

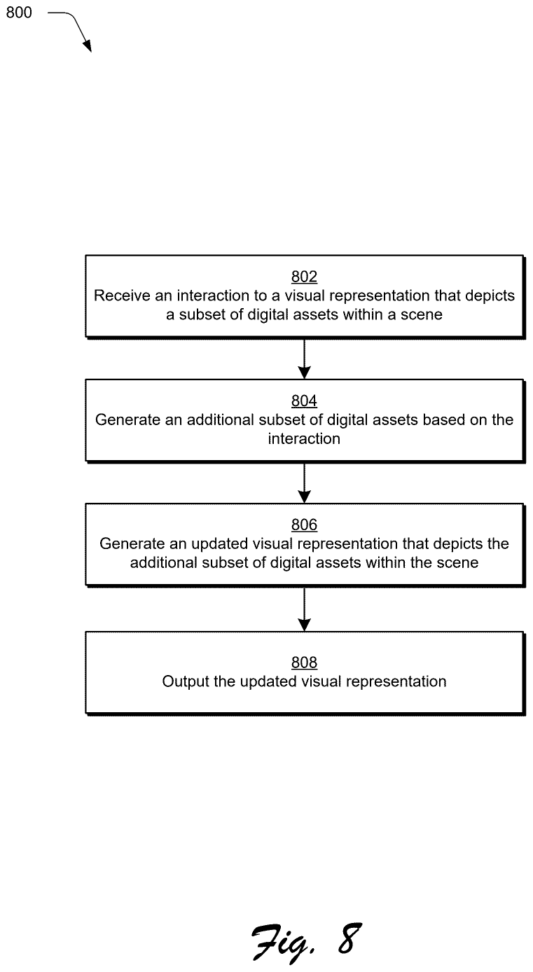

FIG. 8 is a flow diagram depicting an algorithm as a step-by-step procedure 800 in an example implementation that is performable by a processing device to generate an updated interactive visual representation based on an interaction. In various examples, the step-by-step procedure 800 is a continuation and/or variation of the step-by-step procedure 700 described above.

In this example, an interaction to a visual representation is received (block 802). The representation 118, for instance, depicts an asset subset 134 within a scene 128. The interaction 240 includes one or more inputs to elements of the scene, receipt of an updated and/or refined query 122, modification of one or more filters, etc. In at least one example, the interaction 240 is to a particular digital asset 132, such as an action to pin one or more of the digital assets 132 depicted in the representation 118.

An additional subset of digital assets is generated based on the interaction (block 804). For instance, the updated subset 244 includes a particular digital asset 132 from the asset subset 134, e.g., a pinned digital asset 132, and at least one additional digital asset 132 not included in the asset subset 134. In an example, the recommendation model 236 generates the updated subset 244 based on one or more of the pinned digital asset 132, the query intent 204, and/or properties of various digital assets 132 included in the asset database 216. In at least one example, the updated subset 244 is generated based in part on a relationship of digital assets 132 from the asset database 216 to one another.

An updated visual representation is generated that depicts the additional subset of digital assets within the scene (block 806). The updated representation 242, for instance, is generated in accordance with the techniques described above such as with respect to generation of the representation 118. For example, an updated prompt is generated that includes one or more of a representation of the interaction 240 (e.g., the interaction representation 246), a contextual embedding 212, a query intent 204, and/or various instructions 234. A machine learning model, e.g., the generation model 124, processes the updated prompt and the updated subset 244 to generate the updated representation 242.

The updated visual representation is then output (block 808). The updated representation 242, for instance, depicts a substantially similar and/or same scene 128 as the representation 118, however depicts the updated subset 244 rather than the asset subset 134. Accordingly the techniques described herein overcome limitations of conventional techniques that are unable to effectively incorporate objects into generated images and further experience limited control over retaining features in subsequently generated images.

### Example System and Device

FIG. 9 illustrates an example system generally at 900 that includes an example computing device 902 that is representative of one or more computing systems and/or devices that implement the various techniques described herein. This is illustrated through inclusion of the representation module 116. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a user query that includes semantic parameters that define a context of a scene;
correlating, by the processing device, the semantic parameters of the user query to a subset of digital assets stored in an asset database;
generating, by the processing device, a prompt for processing by a machine learning model based on the semantic parameters, the prompt including instructions to generate a visual representation based on the user query; and
presenting, by the processing device and as a result of the processing of the prompt and the subset of digital assets by the machine learning model, the visual representation that depicts the subset of digital assets within the scene.

2. The method as described in claim 1, wherein the correlating the semantic parameters to the subset of digital assets is based in part on a relationship of digital assets stored in the asset database to one another.

3. The method as described in claim 1, wherein the machine learning model is a multimodal image generation model trained to generate images based on one or more of a text-based input or an image-based input.

4. The method as described in claim 3, further comprising receiving a user input that includes a digital image that depicts one or more users, the multimodal image generation model configured to receive the digital image and generate the visual representation to depict the one or more users within the scene engaged with the subset of digital assets.

5. The method as described in claim 1, wherein the prompt further includes a contextual embedding that describes properties of a service provider system associated with the digital assets and properties of one or more of the digital assets.

6. The method as described in claim 1, further comprising generating the visual representation including:
generating, by the machine learning model, a preliminary representation of the scene based on the prompt that does not depict the subset of digital assets; and
generating, by the machine learning model, the visual representation by incorporating the subset of digital assets into the preliminary representation.

7. The method as described in claim 1, wherein the correlating the semantic parameters to the subset of digital assets includes inferring an intent of the user query and identifying, by a multi-item recommender system, digital assets included in the asset database that correspond to the inferred intent.

8. The method as described in claim 1, wherein the visual representation is interactive such that one or more digital assets are selectable within the visual representation to provide additional information about the one or more digital assets.

9. The method as described in claim 1, further comprising receiving an interaction with a particular digital asset of the subset of digital assets within the visual representation and generating an updated visual representation based on the interaction.

10. A system comprising:
a memory component; and
a processing device coupled to the memory component, the processing device to perform operations including:
receiving a query that includes semantic parameters that define a context of a scene;
generating a subset of digital assets from an asset database that includes a plurality of digital assets based on a correlation of the digital assets to the semantic parameters;
generating an input for processing by a machine learning model that includes:
the subset of digital assets; and
a prompt that includes a contextual embedding that describes properties of a service provider system associated with the digital assets; and
generating, as a result of the processing the input by the machine learning model, a visual representation for output in a user interface of the processing device, the visual representation depicting the subset of digital assets within the scene.

11. The system as described in claim 10, wherein the subset of digital assets includes digital images of products provided by the service provider system.

12. The system as described in claim 10, wherein the contextual embedding further includes an asset embedding that describes properties of one or more of the digital assets.

13. The system as described in claim 10, wherein generating the visual representation includes generating a preliminary representation of the scene based on the prompt that does not depict the subset of digital assets and generating the visual representation by incorporating the subset of digital assets into the preliminary representation.

14. The system as described in claim 13, wherein the machine learning model generates the preliminary representation based on processing of the prompt to include one or more contextually adaptable placeholders.

15. The system as described in claim 10, wherein the machine learning model is a multimodal image generation model trained to generate images based on one or more of a text-based input or an image-based input.

16. The system as described in claim 10, wherein the subset of digital assets are further based in part on profile data that describes attributes of an individual associated with the query.

17. A non-transitory computer-readable storage medium storing executable instructions, which when executed by a processing device, cause the processing device to perform operations comprising:
generating, for display in a user interface of the processing device and based on a user query, an interactive visual representation that depicts a subset of digital assets within a scene, the subset of digital assets selected from an asset database based in part on a query intent extracted from the user query;
receiving an interaction with a particular digital asset of the subset of digital assets within the interactive visual representation;
generating an additional subset of digital assets that includes the particular digital asset and at least one additional digital asset based on the interaction and the query intent; and
generating, by a machine learning model, an updated interactive visual representation for display by the user interface that depicts the additional subset of digital assets within the scene.

18. The non-transitory computer-readable storage medium as described in claim 17, wherein the interaction includes a user input to pin the particular digital asset and the updated interactive visual representation replaces an unpinned digital asset of the subset of digital assets with the at least one additional digital asset.

19. The non-transitory computer-readable storage medium as described in claim 17, wherein the subset of digital assets and the additional subset of digital assets are generated based in part on a relationship of digital assets from the asset database to one another.

20. The non-transitory computer-readable storage medium as described in claim 17, wherein generating the updated interactive visual representation includes generating an updated prompt for processing by the machine learning model that includes a representation of the interaction; and processing the updated prompt and the additional subset of digital assets by the machine learning model.
